(19) United States
(12) Patent Application Publication
(10) Pub. No.: US 2002/0139206 A1
(43) Pub. Date: Oct. 3, 2002

(54) Positive/reversed rotation control device

(75) Inventor: Min-Shih Yang, Taipei City (TW)

Correspondence Address: BACON & THOMAS, PLLC, 625 Slaters Lane - 4th Floor, Alexandria, VA, 22314-1176, US

(73) Assignee: Pantech International Inc., Taipei (TW)

(21) Appl. No.: 10/087,813

(22) Filed: Mar. 5, 2002

(30) Foreign Application Priority Data
Mar. 27, 2001 (TW) 90204661

(51) Int. Cl. F16H 3/08

(52) U.S. Cl. 74/404; 74/63

(57) ABSTRACT

A positive/reverse rotation control device comprises a shaft and at least two one-way bearings, wherein the shaft pierces simultaneously through axial apertures of the two bearing, and the two one-way bearings are mounted in opposite directions. Thus, with the shaft rotating positively (e.g., clockwise), the first bearing is to rotate positively (clockwise), and the gear assembly or tooth gage belt pivotally jointed to the first one-way bearing is to be brought to work, whereas the second one-way bearing stays still; when the shaft rotates reversely (e.g., counter clockwise), the second one-way bearing is then to be brought to rotate reversely (counter clockwise), and thus bringing the gear assembly or tooth gage belt pivotally connected to the second one-way bearing to work, whereas the first one-way bearing stays still. Such device can be applied to all kinds of machines or equipment, with only a motor being the driving power, and the user can control the motor by outputting the electrical current in the positive and reverse direction to activate respectively the positive and reverse one-way bearings to work, thus preventing the idleness and waste of space where more than one motor are to occupy, and effectively lowering the cost.

### BACKGROUND OF THE INVENTION

1. Field of the Invention

The positive/reverse rotation control device of the present invention relates to a driving device that, via a single power source (e.g., a motor), brings to rotate the two one-way bearings that, with opposite rotating directions, are pivotally jointed to a shaft, thus such invention effectively decreases the volume for the installment and assembly of extra motors, with the weight being lightened and the cost lowered.

2. Description of the Prior Art

Based on the prior arts, the general means of outputting power in the field is to have a power source (e.g., a motor) to bring to activate driving devices like a set of gears or belts, and only one motion can be completed, so that only one object can be achieved; provided more than one motions are to be desired to complete, a plurality of power sources have to be brought in to respectively activate a set of driving device, so as to complete each motion. Such power outputting means of using a plurality of power sources increases the cost considerably, and also enlarges the volume of the driving device; as to those driving devices that have to be held by hand to operate, the weight increase shall further burden the user during operation and transportation, thus causing operational difficulties and inconvenience.

The conventional portable bundling machine comprises the first motor and the second motor, the first shaft and the second shaft, the first gear assembly and the second gear assembly, the take-up rag wheel, the eccentric shaft and the cutter. One end of the first shaft is pivotally jointed to the first motor, with the first gear assembly pivotally jointed to the first shaft; in the bundling machine, a channeling plate is installed adjacent to the side of the wheel edge of the take-up rag wheel, so as to be the loading surface of the bundling bands; a groove is formed between the loading surface and the wheel edge of the take-up rage wheel, and the take-up rage wheel, installed with protruding teeth along the circumference of the wheel edge, can be brought to rotate by the first gear assembly; the eccentric shaft, pivotally jointed to the second gear assembly, is brought into rotation by the second gear assembly, and forms a coupling device with a vibrating head via the linking lever; thus, through the rotation of the eccentric shaft, the vibrating head is to motion horizontally back and forth.

During bundling, the article to be bundled is to be wrapped first with the bundling band, and then the long side of the flatly overlapping bundling band is to be placed along the rotating direction of the take-up rag wheel into the groove formed between the take-up rag wheel and the channeling plate; when the electrical current is inputted to the first motor to activate the first motor, which brings the first shaft to rotate, the first gear assembly pivotally jointed to the first shaft is further brought to rotate, and at the same time the take-up rage wheel is also brought to rotate; with the friction force produced by the protruding teeth on the wheel edge of the take-up rage wheel, the side of the bundling band coming into contact with the aforementioned protruding teeth is to be dragged, so that the bundling band is to be taken up. After the aforementioned motions, the electrical current is to be inputted to the second motor, which brings the second shaft to rotate, and then the second gear assembly pivotally jointed to the second shaft is further brought to rotate; at this time the second gear assembly is to bring the eccentric shaft to rotate, and with the rotation of the eccentric shaft, the vibrating head is to be brought to motion horizontally back and forth, thus the heat produced by the vibrating head's vibrating and frictionizing the bundling band is used for fusingly jointing the overlapping and taken-up bundling band. Lastly, the cutter is to cut off the superfluous bundling band.

Nevertheless, the first motor and the second motor have to be simultaneously installed in the portable bundling machine, so as to achieve the functions of both the take-up rage wheel's dragging and taking up the bundling band, and the vibrating head's vibrating and fusingly jointing the bundling band. Because of the bulky volume of motors, such a design of using two motors for power input not only increases the overall volume and weight of the bundling machine, causing the operational difficulties and inconvenience for the users, but also leads to tremendous waste of cost due to the expensive production cost for the motors.

### SUMMARY OF THE INVENTION

The present invention is to provide a positive/reverse rotation control device, comprising a shaft and at least two one-way bearings; wherein the shaft pierces simultaneously through the axial apertures of the two one-way bearings, and the two one-way bearings are mounted in opposite directions. With the shaft rotating positively (e.g., clockwise), the first bearing is to rotate positively (clockwise), and the first gear assembly or belt pivotally jointed to the first one-way bearing is to be brought to work, whereas the second one-way bearing stays still. When the shaft rotates reversely (like counter clockwise), the second one-way bearing is then to be brought to rotate reversely (counter clockwise), and thus bringing the second gear assembly or belt pivotally connected to the second one-way bearing to work, whereas the first one-way bearing stays still.

### BRIEF DESCRIPTION OF THE DRAWINGS

These and other features, aspects and advantages of the present invention will become better understood with regard to the following description, appended claims and accompanying drawings that are provided only for further elaboration without limiting or restricting the present invention, where:

FIG. 1 shows a structural perspective view of the components of the present invention;

FIG. 2 shows a structural perspective view of the present invention;

FIG. 3 shows a structural perspective view of the pivotally jointing power source of the present invention;

FIG. 4 shows a left side view of the first preferred embodiment of the present invention;

FIG. 5 shows a right side view of the first preferred embodiment of the present invention;

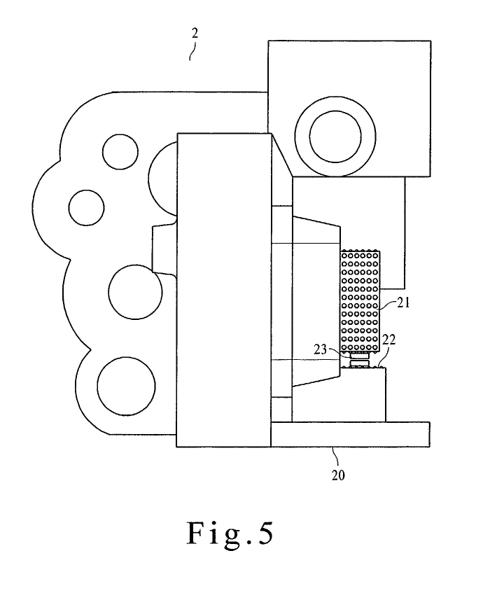

FIG. 6 shows a back side view of the first preferred embodiment of the present invention;

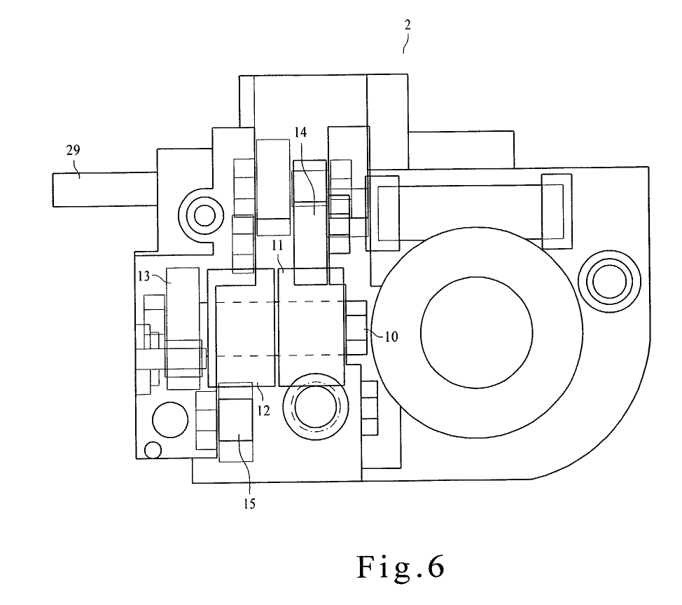

FIG. 7 shows a structural perspective view of the second preferred embodiment of the present invention; and

FIG. 8 shows a right side view of the third preferred embodiment of the present invention.

### DETAILED DESCRIPTION OF THE PREFERRED EMBODIMENT

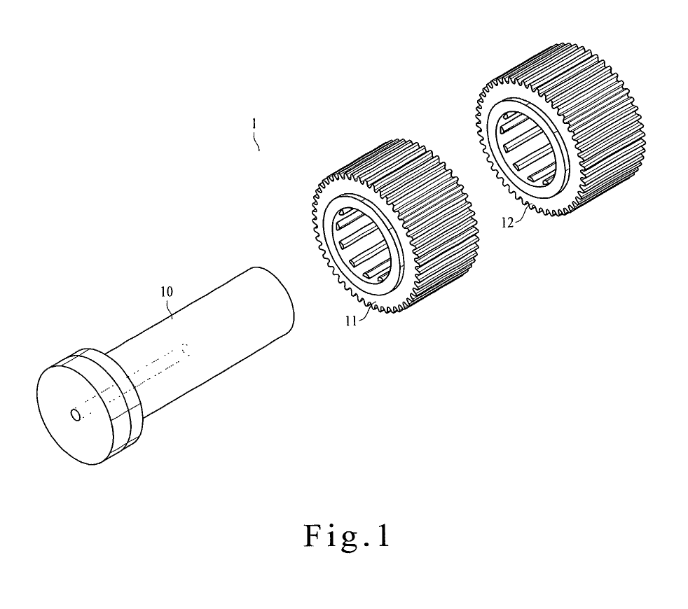

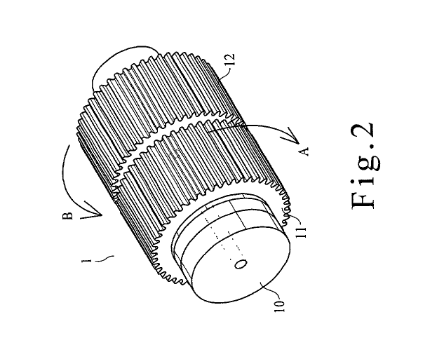

As shown in FIG. 1, the positive/reverse rotation control device 1 of the present invention includes a shaft 10, a first one-way bearing 11 and a second one-way bearing 12, wherein, the outer diameter of the shaft 1 is slightly smaller than the axial apertures of the first one-way bearing 11 and the second one-way bearing 12, so that the shaft 1 can pierce through the axial apertures of the first one-way bearing 11 and the second one-way bearing 12 and closely joint together, so as to bring the bearings into rotation; also the first one-way bearing 11 and the second one-way bearing 12, when being brought to rotate by the shaft 10, can only make one-way rotation, without rotating in the other direction. The way of assembly for the present invention is shown in FIG. 2, wherein the shaft 10 consecutively pierces through the first one-way bearing 11 and the second one-way bearing 12, with the two one-way bearings 11 and 12 mounted in opposite directions; since the two one-way bearings 11 and 12 are in opposite directions, when the shaft 10 rotates in one direction, only a one-way bearing is to be brought to rotate in the same direction with the same rotating speed, with the other one-way bearing stays still; conversely, provided the shaft 10 rotates in the opposite direction, the motions of the two one-way bearings are to be the reverse of the former.

Please continue refer to FIG. 2. To elaborate in detail, when the shaft 10 rotates in direction A (clockwise), the first one-way bearing 11 and the shaft 10 are to rotate in the same direction (clockwise) with the same rotating speed, and since the second one-way bearing 12 is mounted in the opposite direction to the first one-way bearing 11, the second one-way bearing 12 is to stay still. When the shaft 10 rotates in direction B (counter clockwise), the first one-way bearing 11 is to stay still, with the shaft 10 bringing the second one-way bearing 12 to rotate in the same direction (counter clockwise) with the same rotating speed.

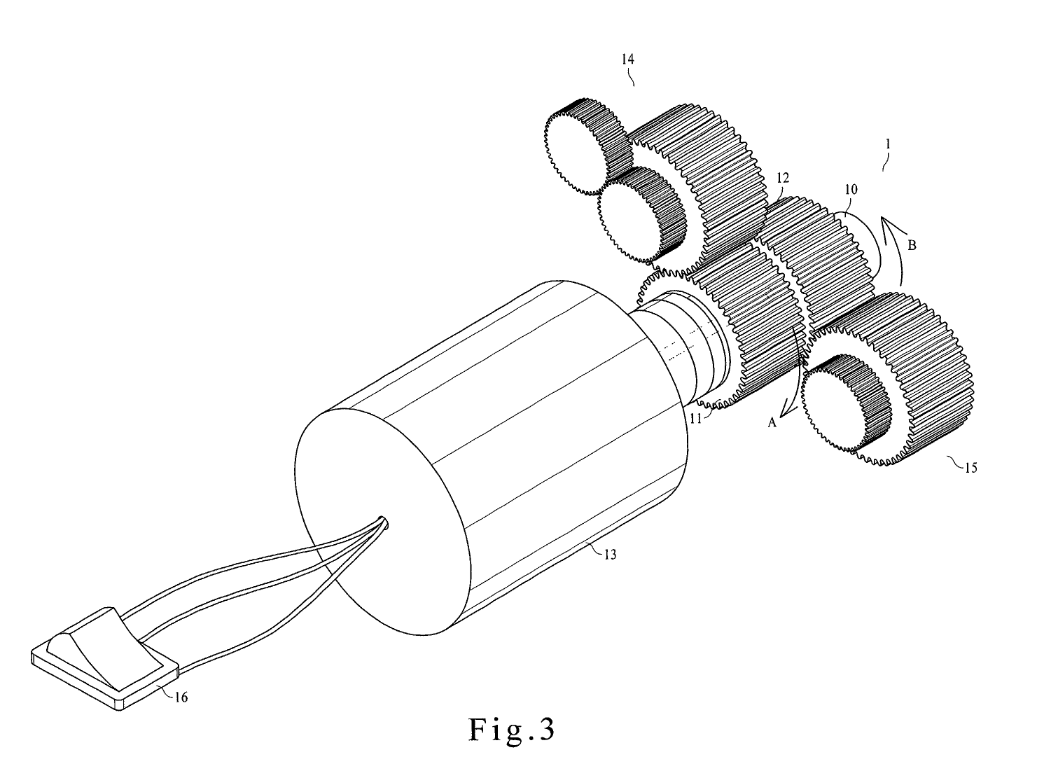

The positive/reverse rotation control device 1 of the present invention further employs the motor 13 that is pivotally jointed to the power source or other kinds of power source to cause the shaft 10 to rotate, as shown in FIG. 3, wherein the axle center of the motor 13 is fixatedly jointed to one end of the shaft 10; the first one-way bearing 11 is pivotally jointed to a first gear assembly 14, and the second one-way bearing 12 is pivotally jointed to a second gear assembly 15, with the power source pivotally jointed to a power source switch 16, so that the positive and negative electrodes can be switched. When the power source switch 16 switches, conducts and inputs the current with the positive electrode of the power source connecting to the positive electrode of the motor 13, and the negative electrode of the power source connecting to the negative electrode of the motor 13, the motor 13 is activated to rotate in direction A (clockwise), and at the same time the shaft 10 and the first one-way bearing 11, brought into rotation by the motor 13, are to rotate in the same direction (clockwise) with the same speed, and then the first gear assembly 14 is brought to rotate, by which the power is to be transmitted, and the mechanical object can be further achieved, whereas the second one-way bearing 12 is to stay still. When the power source switch 16 switches, conducts and inputs the current with the positive electrode of the power source connecting to the negative electrode of the motor 13, and the negative electrode of the power source connecting to the positive electrode of the motor 13, the motor 13 is activated to rotate in direction B (counter clockwise), and at the same time the shaft 10 and the second one-way bearing 12, brought into rotation by the motor 13, are to rotate in the same direction (counter clockwise) with the same speed, and then the second gear assembly 15 is brought to rotate, by which the power is to be transmitted, and the mechanical object can be further achieved, whereas the first one-way bearing 11 is to stay still. It goes without saying that the means of power transmission in the present invention is not limited to the use of gears, for any apparatus that can transmit power is allowed, such as tooth gage belt; furthermore, the power source is not limited either, for any power source used in general industries like motors or pneumatic mechanisms is allowed.

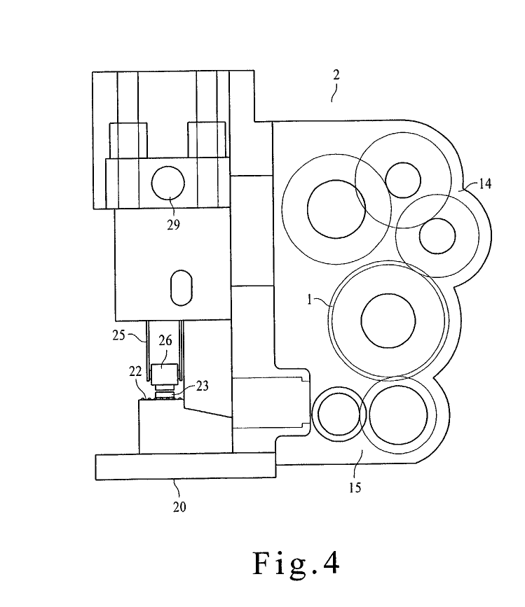

The positive/reverse control device 1 of the present invention is further installed in the portable bundling machine 2, with the embodiments thereof shown in FIG. 4, 5 and 6, respectively the left side view, the right side view and the back side view; wherein, the bundling machine 2 comprises a grip portion 29 for the user to grip during operation, and a base 20 enabling the bundling machine 2 to be placed on top of the article ready to be bundled. The upper surface of the front edge of the base 20 is installed with a band-shaped containing surface 22 that, parallel with the direction of the bundling band 23 being tightly pulled, is used for containing the overlapping portion of the bundling band 23 that is placed in parallel into the containing surface 23 from the direction perpendicular to that of the bundling band 23 being tightly pulled, thus making the lower side of the overlapping portion of the bundling band 23 contacting the protruding teeth on the surface of the containing surface 22; a take-up rag wheel 21 having its rotating direction parallel to that of the bundling band 23 being tightly pulled is installed on top of the containing surface 22, with the wheel edge of the take-up rag wheel 21 being installed with the protruding teeth also. The take-up rag wheel 21 is pivotally jointed to the first gear assembly 14 by which the take-up rag wheel 21 can be brought to rotate. An eccentric wheel (not shown in figures), pivotally jointed to the second gear assembly 15, is connected to a linking lever assembly 25, with one end of the linking lever assembly 25 installed with a slider vibrating head 26; thus, with the second gear assembly 15 rotating and therefore bringing the eccentric wheel to rotate as well, the linking lever assembly 25 is brought to activate and then brings the vibrating head 26 to make horizontal motions back and forth.

The power source of the portable bundling machine 2 of the present invention is installed with a circuit board circuit device (not shown in figures); thus, with such circuit device controlling the direction of the electrical current inputted to the motor 13, when the positive\reverse control device 1 of the present invention inputs the positive electrical current, the first one-way bearing 11 brings the first gear assembly to work, and then further brings the take-up rag wheel 21 to rotate; during which the protruding teeth of the take-up rage wheel 21 is to come into contact with the bundling band 23 on top of the overlapping portion, enabling the take-up rage wheel 21 to drag and take up the bundling band 23; the bundling band 23 under the overlapping portion is to be fixated by the protruding teeth of the containing surface 22 to prevent the bundling band 23 from sliding during the process of taking in, and then the circuit device automatically controls the taking-in period of time, thus when the bundling is completed, the inputting of the positive electrical current is to be stopped.

Subsequently, the circuit device automatically controls and inputs the electrical current in reversed direction, and at this time, the first one-way bearing 11 stops to work, whereas the second one-way bearing 12 rotates and bring the second gear assembly 15 to work, through which the eccentric wheel is brought to work, and then the linking lever 25 is brought to work and further brings the vibrating head 26 to motion horizontally back and forth. Therefore, with the circuit device controlling the vibrating head 26 to motion and frictionize with high speed for several seconds, the bundling band 23 on top shall be fused by the heat and then jointed with the bundling band 23 underneath, and when the motions of frictionizing, fusing and jointing stop, the blade of the cutter is to cut off the superfluous bundling band 23 on top simultaneously, thus completing the fusing, jointing and cutting procedures on the bundling band 23.

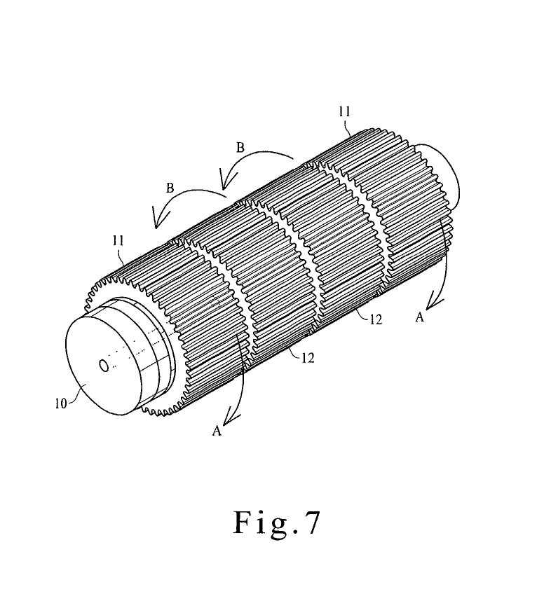

Another embodiment of the positive/reversed rotation control device 1 of the present invention is shown in FIG. 7, wherein the shaft 10 can be further jointed pivotally with a plurality of the first one-way bearing 11 and a plurality of the second one-way bearing 12, with every one of which being able to be pivotally jointed to the gear assembly and thus bring the gear assembly to work, and eventually complete one mechanical object respectively. It goes without saying that the means of power transmission in the present invention is not limited to the use of gears, for any apparatus that can transmit power is allowed, such as tooth gage belt; furthermore, the power source is not limited either, for any power source used in general industries like motors or pneumatic mechanisms is allowed.

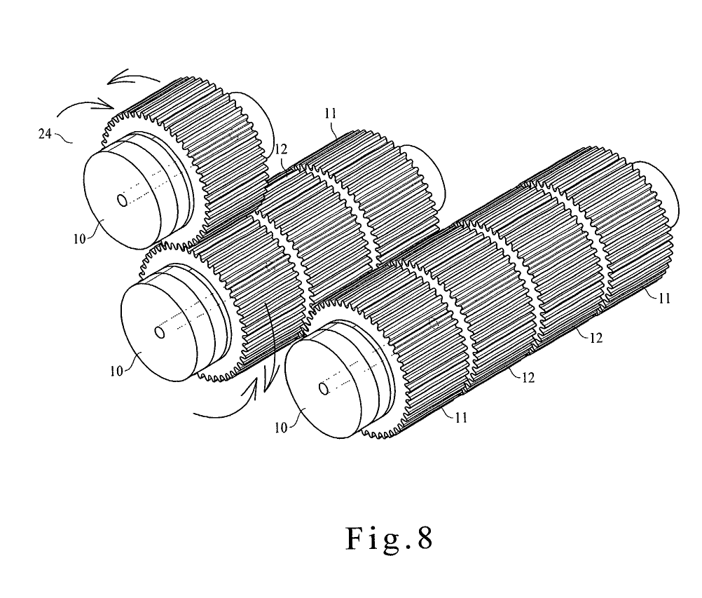

Another embodiment of the positive/reversed rotation control device 1 of the present invention is shown in FIG. 8, wherein the gear assembly, brought to work by the first one-way bearing 11 or the second one-way bearing 12, is installed with another first one-way bearing 11 or another second one-way bearing 12, thus another set of the positive/reversed rotation control device 1 can be brought to work by the one-way bearing 11 or one-way bearing 12 within the gear assembly; such a positive/reversed rotation control device 1 can also be installed with the gear assembly 24, thus, with the positive or reversed rotation of the positive/reversed rotation control device 1, the gear assembly 24 is to make positive or reversed rotation, through which power is to be transmitted, eventually completing at least two mechanical objects. It goes without saying that the means of power transmission in the present invention is not limited to the use of gears, for any apparatus that can transmit power is allowed, such as tooth gage belt; furthermore, the power source is not limited either, for any power source used in general industries like motors or pneumatic mechanisms is allowed.

Although the present invention has been described in considerable detail with reference to certain preferred embodiments thereof, those skilled in the art can easily understand that all kinds of alterations and changes can be made within the spirit and scope of the appended claims. Therefore, the spirit and scope of the appended claims should not be limited to the description of the preferred embodiments contained herein.

What is claimed is:

1. A positive/reversed rotation control device, comprising a shaft and two one-way bearings, wherein two said bearings are pivotally jointed to said shaft respectively and differently in positive and reversed direction; with said shaft's rotating in positive direction, said one-way bearing in the positive direction is to be brought to rotate in the same direction with the same speed, or with said shaft's rotating in reversed direction, said one-way bearing in the reversed direction is to be brought to rotate in the same direction with the same speed.

2. A positive/reversed rotation control device as in claim 1, wherein said shaft is pivotally jointed to a motor; with said motor's rotating positively or reversely, said bearings in both positive and reversed directions are to be respectively brought to rotate.

3. A positive/reversed rotation control device as in claim 1, wherein said shaft is pivotally jointed to a pneumatic apparatus, whereby the shaft is to be brought to rotate in positive or reversed direction.

4. A positive/reversed rotation control device as in claim 1, wherein said one-way bearings are pivotally jointed to transmission device, thus said one-way bearings can bring said transmission apparatus to work and transmit power.

5. A positive/reversed rotation control device as in claim 4, wherein said transmission apparatus is of gear assembly or tooth gage assembly.

6. A positive/reversed rotation control device as in claim 2, wherein said motor is pivotally jointed to the power source, and the switch is installed thereon for switching and conducting the power source that is in positive or reversed direction.

7. A positive/reversed rotation control device as in claim 4 or 5, wherein said transmission apparatus is pivotally jointed to another positive/reversed rotation control device.
